(19) United States
(12) Patent Application Publication
(10) Pub. No.: US 2008/0131097 A1
(43) Pub. Date: Jun. 5, 2008

(54) Information recording/reproducing apparatus

(75) Inventor: Gen Okazaki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd, Tokyo (JP)

(21) Appl. No.: 11/982,537

(22) Filed: Nov. 2, 2007

(30) Foreign Application Priority Data
Dec. 1, 2006 (JP) 2006-325137

(51) Int. Cl. H04N 5/00

(52) U.S. Cl. 386/126

(57) ABSTRACT

A video camera, installing a hard disc and an optical disc therein, as recording media for recording video information thereon, wherein: a housing of the video camera is conducted with a main body housing, and a recording media cover, which can be freely rotated to the main body housing, to be opened/closed; the recording media cover is so structured to be fitted and engaged with, by sliding a hard disc cover to an optical disc cover, by means of an engagement member; the optical disc is loaded detachably within the main body housing of the video camera, by rotationally opening/closing the recording media cover; and the hard disc is disposed in an interior space defined by the optical disc cover and the hard disc cover, under such condition that engagement condition of the recording media cover by means of the engagement member can be removed by only a specific removal member, from an outside thereof.

### BACKGROUND OF THE INVENTION

The present invention relates to an information recording/reproducing apparatus.

In the following Patent Document, there are described a problem, “In general, with the conventional image pick up apparatus, in particular, having a cassette tape and recording medium other than that, i.e., various kinds of recording media, each being different from each other, the other recording medium comes out every time when a cassette cover is opened, even if a user wishes to take out only one of them. For that reason, the operation comes to be difficult, and also a portion for receiving the other recording medium works; thereby wasting electric power accompanying the upcoming of the other recording medium” is dissolved by using a means, “An image pickup apparatus, according to the present invention, having a plural number of image pickup modes and having different kinds removable recording media for enabling image pickup modes, wherein one of the recording media is inhibited from detachable operation thereof”.

[Patent Document 1] Japanese Patent Laying-Open No. 2004-193678 (2004) (see [0004] and [0006]).

In recent years, a video camera is under the situation that it adopts various recording media for information, accompanying with the development of digital recording technology. Thus, as the recording medium, not only video tape, but also various kinds of media are installed, such as, an optical disc, a hard disc and a memory card, etc., employing the respective characteristics thereof, and further, the video camera achieves an improvement in operability or usability when recording and/or storing, by installing a plural number of recording media, in a combination therewith.

In this manner, the video camera using the plural number of recording media therewith can achieve the improvement in operability or usability when recording and/or storing, but there is also necessity of keeping an easiness of maintenance thereof, for dealing with troubles in the respective recording media, as quickly as possible.

In this respect, the Patent Document 1 describes about a video camera installing the plural number of recording media therein, but there is paid no consideration of keeping the easiness of maintenance of each of the recording media.

Further, when installing the plural number of recording media therein, and/or enlarging the recording capacity of the hard disc built within the video camera, it brings about a possibility of enlargement of the video camera, but the Patent Document 1 never pays the consideration on a position and an arrangement for installing each of the recording media, for achieving small-sizing of the video camera.

### BRIEF SUMMARY OF THE INVENTION

Then, according to the present invention, an object thereof is to provide a video camera for dissolving those problems.

For dissolving the problems mentioned above, according to the present invention, there is provided a video camera having the structures as described in the present pending claims attached.

According to the present invention, it is possible to provide a video camera being preferable or superior in the operability or usability thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is an external perspective view of a video camera for showing an outlook thereof, according to an embodiment of the present invention;

FIG. 2 is an external perspective view for showing the condition of opening a recording media cover for installing a recording medium, i.e., an optical disc, therein, within the video camera, according to the present invention;

FIG. 3 is an external perspective view for showing the recording media cover for installing a hard disc, as one of the recording media, according to the present invention;

FIG. 4 is a perspective vide of showing the recording media cover 5 shown in FIG. 3 mentioned above, when seeing it from the inside thereof;

FIG. 5 is an exploded view of the recording media cover, according to the present invention;

FIG. 6 is an external view of the video camera, according to the present invention;

FIG. 7 is a cross-section view of the video camera, according to the present invention; and

FIG. 8 is an external perspective view of the video camera according to the conventional art.

### DETAILED DESCRIPTION OF THE PREFERRED EMBODIMENTS

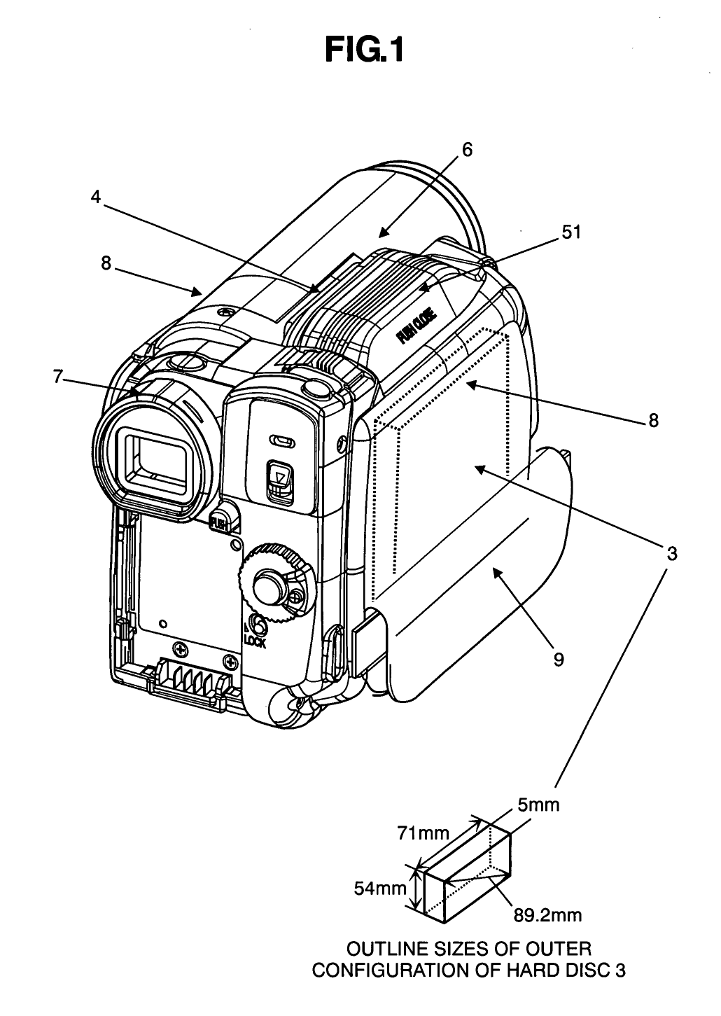

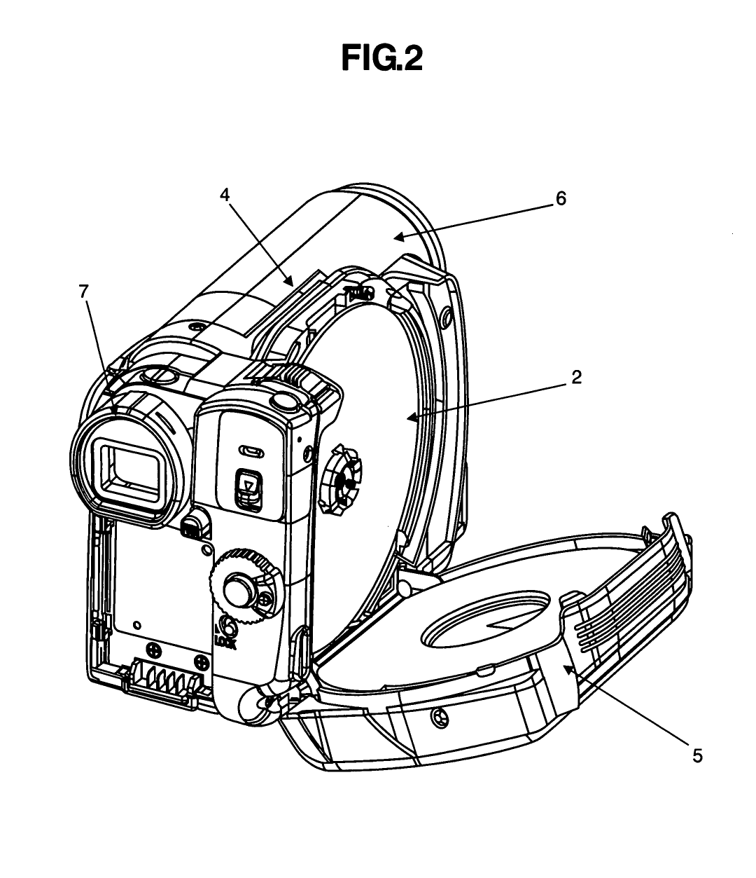

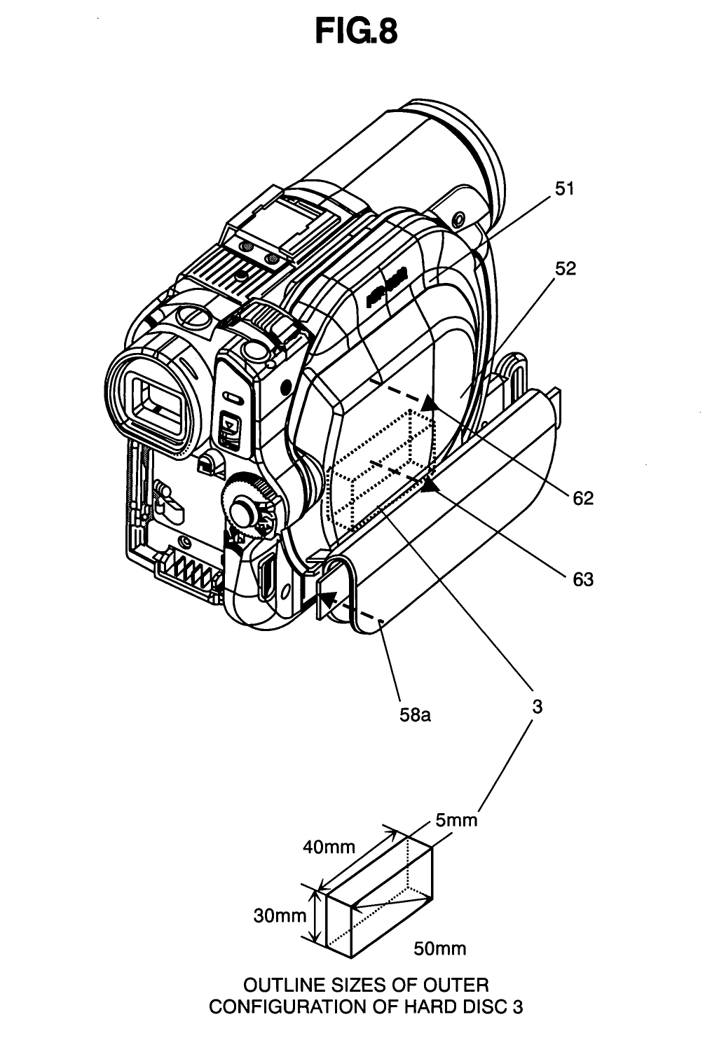

Hereinafter, embodiments according to the present invention will be fully explained by referring to the attached drawings. FIG. 1 is a perspective external view of a video camera for showing an outlook thereof, according to an embodiment of the present invention. FIG. 2 is a perspective external view for showing the condition of opening a recording media cover for installing a recording medium, i.e., an optical disc, therein, within the video camera, according to the present invention. FIG. 8 is an external perspective view of the video camera according to the conventional art.

A video camera 1 shown in FIGS. 1, 2 and 8 installs an optical disc 2 and a hard disc 3 there, as recording media thereof, and as is shown in FIG. 2, the optical disc 2 is installed within a main body of the video camera 1, and the hard disc is held within a recording media cover 5 in one body, but in such a manner that it can be taken out by a special tool, such as, a precision driver, etc., for example. A diameter of the optical disc 2 is about 80 mm.

On a housing 4 of video camera, in particular, on the side of the main body thereof, there are held an optic lens portion 6, for optically inputting an object to be picked up therein, a view finder 7, for displaying a picture, etc., when picking up an image or when reproducing, and a liquid crystal display portion 8 (not shown because it is disposed on the rear surface of the drawing), etc., through a mechanism frame (not shown in the figure). Further, on the housing 4 of the video camera main body is held the recording media cover 5, which can be opened freely, for installing the optical disc 2 into the main body. Installation/discharge of the optical disc 2 into/from the video camera 1 can be done, in the similar manner to that of the conventional recording medium, by opening/closing the recording media cover 5; i.e., attaching or detaching it on a loading member of the disc 2 of the video camera 1, in the structures. Herein, provision of a hard disc, i.e., one of the recording media, according to the present invention, it is provided within the recording media cover 5, for the purpose of small-sizing of the video camera 1.

Within the video camera shown in FIG. 8 is applied a hard disc of 1-inch type, and the sizes of the external configuration thereof are as shown in the figure. Also, the hard disc is fixed in a space defined by an optical disc cover 51 and a hard disc cover 52. Among screws used for fixing the hard disc cover 52, the screws in the direction perpendicular to a recording surface of the optical disc are three (3) in the pieces thereof, 58a, 62 and 63, as shown in the figure. The screw 58a is provided from an outside of the hard disc cover 52, while the screws 62 and 63 are provided from the side located on the optical disc cover 51. The respective screws are disposed within an outside of the surface of the hard disc.

In this manner, the size on a diagonal line is about 50 mm if it is the hard disc of the conventional 1-inch type, i.e., it is smaller than the diameter of the optical disc 2. For this reason, it was possible to fix the hard disc cover 52, without enlarging the video camera as a whole, even if providing the plural number of the screws in the direction perpendicular to the recording surface of the optical disc 2.

On the other hand, outlook sizes are shown in FIG. 1, of the external configurations of 1.8-inch type hard disc, which is to be applied, according to the present invention. In this manner, the size of the hard disc to be applied, according to the present invention, is about 89.2 mm, on the diagonal line thereof; it is larger than the diameter of the optical disc 2. For that reason, in case when applying the 1.8-inch type hard disc, the entire of the video camera is enlarged if providing the screws in the plural number thereof, in the perpendicular direction to the recording surface of the optical disc 2.

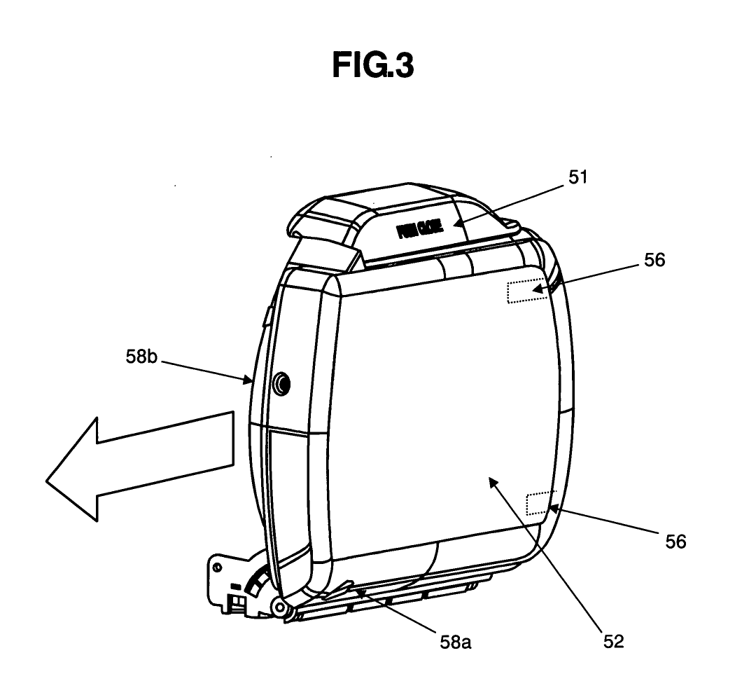

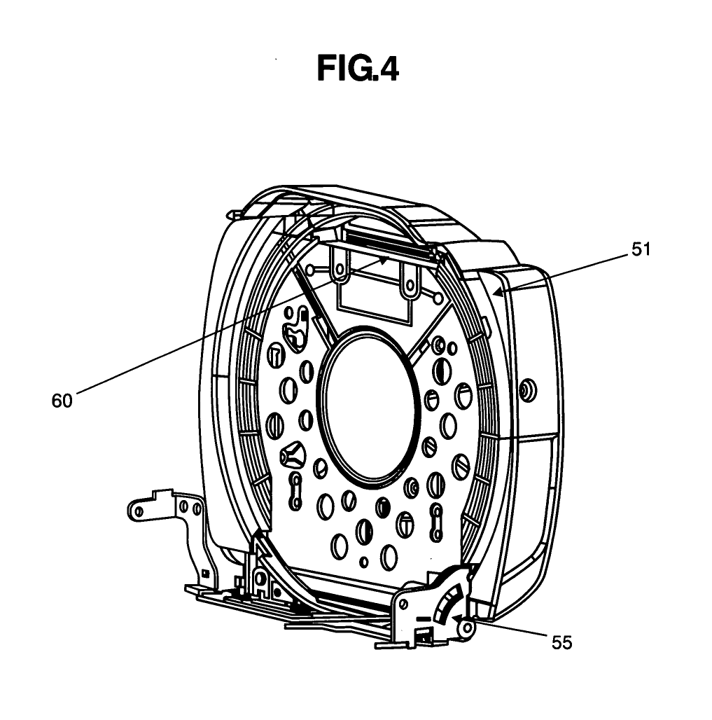

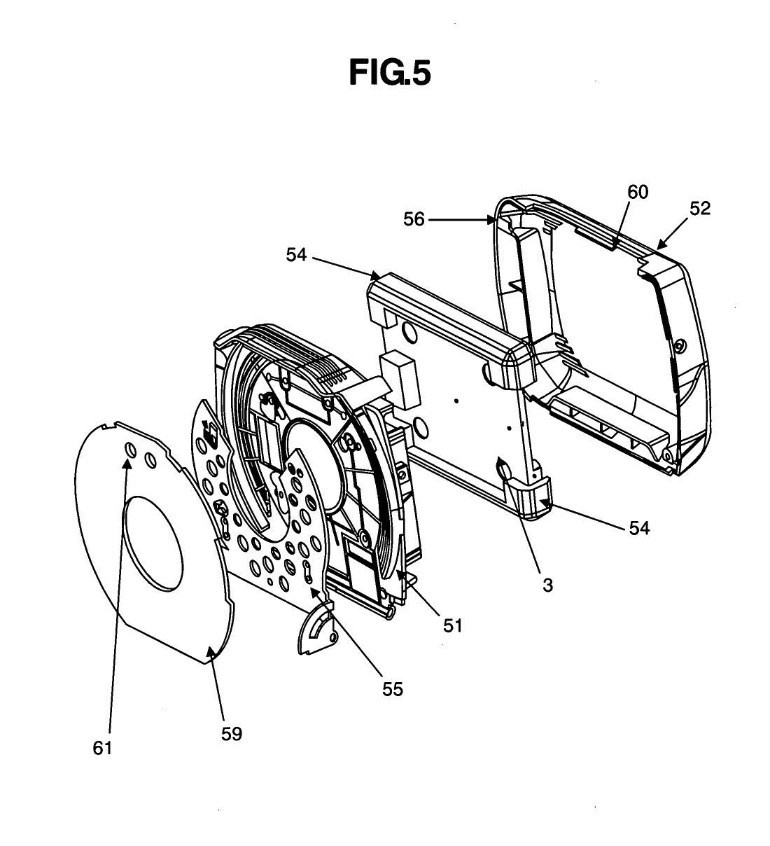

Then, explanation will be made on the condition of installing the hard disc 3, according to the present invention. FIG. 3 is an external perspective view for shown the recording media cover 5 for installing the hard disc 3, i.e., one of the recording media, according to the present invention. FIG. 4 is a perspective view for showing the recording media cover 5 shown in FIG. 3, when seeing it from an inside thereof. FIG. 5 is an exploded perspective view of the recording media cover 5, according to the present invention.

As is shown in FIG. 5, the recording media cover 5 is constructed with the optical disc cover 51 and the hard disc cover 52, and the hard disc 3 is built in, being held between the optical disc cover 51 and the hard disc cover 52 in one body, in the structures thereof. Further, a rotation support member 55, for rotationally open/close the recording media cover 5 with respect to the housing 4 on the side of the main body, is coincide or fitted with the recording media cover in one body, by means of screws not shown in the figure, or the like. Further, between the optical disc 2 and the rotation support member 55 is pasted a dumper member 59 for escaping it from contacting on the optical disc 2.

Herein, when photographing by means of the video camera 1, it is held on a surface, on which the liquid crystal display is attached, and a handgrip band 9, which is attached on the opposite surface thereof. Thus, it is held is such a manner; wrapping the hard disc cover 52 of the recording media cover 5 in the palm of a hand, while passing the hand through the handgrip 9 from below, and letting the handgrip band 9 to push the back of the hand, while attaching a tip of a finger on an upper side portion of the optical disc cover 51. Since the usable modes of the video camera 1 can be expanded through enlarging the recording capacity of the hard disc 3 to be installed, as far as possible, then it is preferable to install a hard disc having a disc size as large as possible. However, although the position where the hard disc is disposed set at the handgrip portion, as was mentioned previously, for supporting the video camera 1, but it is preferable to adopt such the structures that the hard disc to be installed is not limited by a manner of supporting by the hand.

As is shown in FIG. 3, it is so constructed that the hard disc cover 52 can be slid into the direction shown by an outlined arrow, to be fitted or engaged with the optical disc cover 51. Thus, the sliding direction for fitting is the direction perpendicular to the direction of gripping the handgrip. Behind the hard disc cover 52 in the sliding direction are provided a plural number of fitting claws 56. The fitting claws 56 of the hard disc cover 52 are engaged with members 57 to be engaged with, which are provided on the optical disc cover 51, thereby being held while positioning each other. After that engagement, it is screwed by a screw 58b at a front-end portion of the hard disc cover 52, in the sliding direction thereof. In this manner, it is possible to escape from loosening of the engagement or fitting due to deformation, etc., by directing the engagement or fitting between the hard disc cover 52 at the handgrip portion, in which the hard disc is installed, and the optical disc cover 51, into the direction, being perpendicular to the direction of griping by the hand, and thereby achieving a stable condition for insertion of the hard disc.

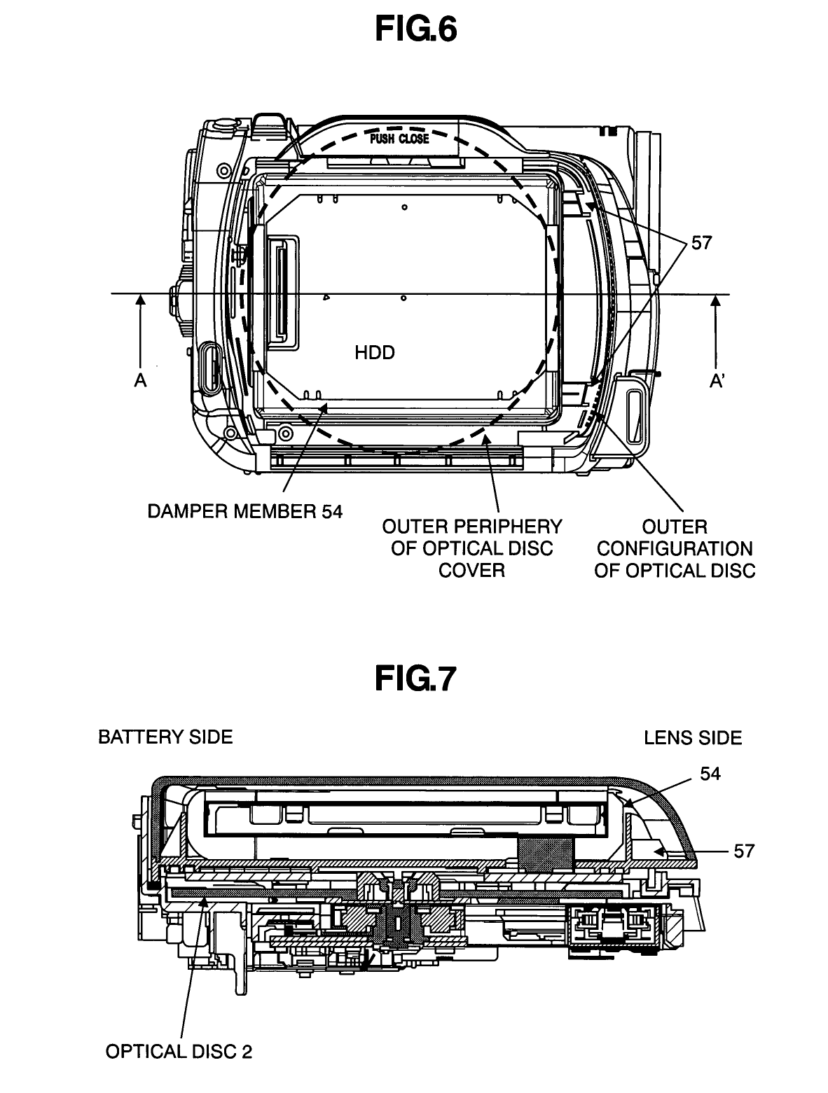

FIG. 6 is an external view of the video camera, under the condition of removing the hard disc cover 52 therefrom. In the figure, an outer configuration of the optical disc and an outer periphery of the optical disc cover are shown by broken lines. FIG. 7 is a view for showing, easily, the cross-section cut along A-A′ line in FIG. 6, under the condition of providing the hard disc cover thereon.

In this manner, with removing the conventional screws 62 and 63 from the hard disc, and also engaging the fitting claw 56 with 57, it is possible to coincide the outer peripheries of the hard disc cover and the optical disc cover, thereby achieving space saving of the members for fixing the hard disc. For that reason, it is possible to prevent the video camera as a whole from large-sizing thereof, with providing the hard disk of 1.8-inch type, stably, within the video camera, i.e., a hard disc having a size larger than the hard disc in the diameter thereof. In this manner, it is possible to achieve the both, i.e., enlargement of the recording capacity of the hard disc, and prevention of the video camera from large-sizing thereof.

Further, the engagement between the optical disc cover 51 and the hard disc cover 52 is achieved by an engagement portion 60, which is automatically rotated by the sliding. Herein, the fitting claw 56 is the member of engaging with the 57 without elastic deformation thereof, but on the contrary, the engagement portion 60 is also a claw-like member, but it is the member to be engaged with the optical disc cover 51 after being elastically deformed once when being engaged. In case of necessity of removing the hard disc 3 therefrom, due to, such as, a trouble in the hard disc 3, for example, a special tool being sharp at the tip thereof, such as, a pincette or tweezers, is inserted into two (2) pieces of holes 61 provided on the damper member 59, then the engagement between the optical disc cover 51 and the hard disc cover 52 can be removed through an opening provided on the optical disc cover 51. This structure is for the purpose of inhibiting the user not to remove the hard disc 3, erroneously, and it ensures the safety in relation to installation of the hard disc 3.

Also, comparing to the conventional video camera, the hard disc cover is fixed with using the claw-like engagement portion 60, removing the screws that were used for fixing the hard disc, and therefore, it can be removed easily. With this, it is possible to ensure the easiness of maintenance in case when the hard disc must be removed, such as, when a trouble occurs in the hard disc, etc., for example.

With such the structures as was mentioned above, it is possible to provide a small-size video camera, having reliability, making the hard disc removable to be repaired when it is in the trouble, while escaping the hard disc drive from being removed by the user, in particular, within the video camera installing the hard disc drive therein.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A video camera, installing a hard disc and an optical disc therein, as recording media for recording video information thereon, wherein:
a housing of said video camera is conducted with a main body housing, and a recording media cover, which can be freely rotated to said main body housing, to be opened/closed;
said recording media cover is so structured to be fitted and engaged with, by sliding a hard disc cover to an optical disc cover, by means of an engagement member;
said optical disc is loaded detachably within the main body housing of said video camera, by rotationally opening/closing said recording media cover; and
said hard disc is disposed in an interior space defined by said optical disc cover and said hard disc cover, under such condition that engagement condition of said recording media cover by means of the engagement member can be removed by only a specific removal member, from an outside thereof.

2. The video camera, as described in the claim 1, wherein
the engagement between said optical disc cover and said hard disc cover has such a structure that said hard disc cover is engaged with or separated from said optical disc cover by a sliding operation through a guiding member, and
a claw-like members to be engaged with said optical disc cover is provided at a rear portion of said optical disc cover in sliding direction thereof, wherein it is engaged with, by screwing said disc cover by a screw, at least in a front thereof, in the sliding direction of said disc cover, under condition of being engaged with at a predetermined position through sliding.

3. The video camera, as described in the claim 2, wherein
the sliding direction of said hard disc cover is nearly perpendicular to a direction of gripping a handgrip.

4. An information recording/reproducing apparatus, having a hard disc drive for driving a hard disc and an optical disc driver for driving an optical disc, having:
a main body housing; and
a recording media cover, wherein
said optical disc is loaded detachable between said main body housing and said recording media cover,
said recording media cover has an optical disc cover and a hard disc cover, being provided to be rotationally opened/closed to said main body housing, and
said hard disc, a diagonal line size of which is longer than a diameter of said optical disc in on a surface parallel with said hard disc, is provided between said optical disc cover and said hard disc cover, and said hard disc cover has a claw-like portion to be slid to said optical disc cover to be engaged with, so that they are provided in engagement with each other by said claw-like portion, fitting outer peripheries of said hard disc cover and said optical disc cover.

5. The information recording/reproducing apparatus, as described in the claim 4, wherein,
said main body housing has a control substrate, and
wiring for connecting said hard disc drive and said substrate is disposed at a hinge portion, around which said recording media cover opens/closes.

6. The information recording/reproducing apparatus, as described in the claim 4, wherein,
a rotation center of said optical disc drive is shifted from a rotation center of said hard disc.

7. The information recording/reproducing apparatus, as described in the claim 4, wherein
said hared disc drive is a 1.8-inch type hard disc drive.

8. The information recording/reproducing apparatus, as described in the claim 5, wherein
said hared disc drive is a 1.8-inch type hard disc drive.

9. The information recording/reproducing apparatus, as described in the claim 6, wherein
said hared disc drive is a 1.8-inch type hard disc drive.

10. The information recording/reproducing apparatus, as described in the claim 4, wherein
a diameter of said optical disc drive is 80 mm.

11. The information recording/reproducing apparatus, as described in the claim 5, wherein
a diameter of said optical disc drive is 80 mm.

12. The information recording/reproducing apparatus, as described in the claim 6, wherein
a diameter of said optical disc drive is 80 mm.

13. The information recording/reproducing apparatus, as described in the claim 7, wherein
a diameter of said optical disc drive is 80 mm.

14. The information recording/reproducing apparatus, as described in the claim 8, wherein
a diameter of said optical disc drive is 80 mm.

15. The information recording/reproducing apparatus, as described in the claim 9, wherein
a diameter of said optical disc drive is 80 mm.
